(19) United States
(12) Patent Application Publication
(10) Pub. No.: US 2009/0022559 A1
(43) Pub. Date: Jan. 22, 2009

(54) Rotary tube notching apparatus

(76) Inventor: Robert K. Hughes, JR., Ocala, FL (US)

Correspondence Address: DOUGLAS WM. MASSINGER, ESQUIRE;MASSINGER LAW OFFICES, 887 N.E. 100 STREET, OCALA, FL, 34479, US

(21) Appl. No.: 11/879,415

(22) Filed: Jul. 16, 2007

(51) Int. Cl. B23B 39/00

(52) U.S. Cl. 408/103

(57) ABSTRACT

A rotary tube notching apparatus capable of operable attachment to a powered rotational drive device such as a drill, is comprised of a surface mountable tube support assembly capable a length of straight tubing to be notched; a height adjustable carriage assembly slidably mounted to the tube support assembly to enable offset notching, a turret assembly rotatably mounted to the carriage assembly to enable angled notching, and a shaft rotatably and slidably mounted within said turret assembly for receiving a cutting tool.

### FIELD OF THE INVENTION

The subject invention relates to tube notchers generally, and to an adjustable rotary tube notching apparatus capable of performing straight, angled and offset cuts in both straight and bent tubing, in particular.

### BACKGROUND OF THE INVENTION

In order to manufacture products comprised of tubular metal, such as automotive exhaust systems, roll-cages and numerous other framed support structures, it is necessary to join sections of hollow metal tubing by means of arc welding, electron beam welding, laser welding and brazing or soldering. In order to accomplish proper interconnection of such tubing members for permanent union it is first necessary to “notch” one of the tubes so that it matingly conforms to the exterior surface of the tube to which it is to be connected. Several methods have been employed to achieve the desired fit of such abutting tubular surfaces including the use of hand-held coping tools, punch and die combinations and band saws. The subject invention relates to yet another species of notching apparatus, namely a rotary cutting tool or “hole saw”.

Heretofore, a variety of rotary cutting devices have been designed to produce precisely contoured ends of tubing for connection with the periphery of another tubing member. Some such devices are hand-held while others are surface mounted. Of this latter type, some are designed to maintain the cutting tool in vertical orientation above the work piece, such as by mounting the device in a drill press or in a vice and attaching a hand drill. The orientation of the work piece relative to the cutting tool is then manipulated to achieve the proper angle of penetration. A first problem with this arrangement is that there is often insufficient room to properly position elongate tube members since movement is impeded by either the floor (when adjusting the tube about a vertical plane) or by surrounding walls or other table mounted equipment (when adjusting the tube about a horizontal plane). A second problem frequently encountered is that the weight of the hand drill causes the cutting member to descend too rapidly into the work piece which can result in binding and/or damage to the work piece.

In order to obviate the shortcomings and limitations of the above described prior art surface-mounted tube notching devices it has been found useful to achieve the desired angles of penetration by retaining the work piece in a fixed and preferably horizontal position while adjusting the orientation of the cutting tool relative thereto, rather than visa versa. One such device is described in U.S. Pat. No. 5,118,228 issued to Story in 1992. Story teaches that a length of steel tubing may be confined within a pipe support unit using clamping means and an articulated cutter head unit may then be aligned to intersect the midpoint of the steel tubing at a desired angle. The key here is that the work piece remains stationary and secure while the cutter head is disposed at a selected angular orientation relative to the work piece. The hand drill is then attached to the shaft of the cutter head to impart rotary motion. An apparent shortcoming of the Story device, is that the carriage unit which supports the cutter head unit is comprised of two relatively thin and elongated arms which are likely to bend under the weight of an attached hand drill thereby causing misalignment of the cutting head and pipe.

Moreover, tube notching devices of the prior art are neither designed for nor suited to create offset notches in the work piece (i.e., where the center of the hole saw does not intersect the longitudinal axis of the work piece). In view of the shortcomings and limitations of the prior art there has existed a longstanding need for a rotary tube notching apparatus designed to securely hold straight tubing and having means for adjusting the orientation of the cutting mechanism about both a horizontal and vertical plane such that it may create straight, angled and offset notches in the work piece. The subject apparatus fulfils these objectives and others as set forth in greater detail herein.

### SUMMARY OF THE INVENTION

The subject invention more specifically relates to a rotary tube notching apparatus capable of operable attachment to a powered rotational drive device such as a drill, the notching apparatus being generally comprised of a vertical frame having a tube support assembly mounted thereon for retaining a work piece in a fixed position against the frame; a height adjustable carriage assembly slidably mounted to the frame, a turret assembly pivotally mounted to the carriage assembly, and a shaft rotatably mounted within the turret assembly.

In practice a cutting tool, namely a hole saw, and a hand drill are operatively mounted to opposite ends of the shaft assembly in traditional fashion. A length of straight tubing is then secured to the frame via tube retention means. Thereafter, the turret assembly will be rotated about its pivot point until the axis of rotation of the cutting tool is aligned to intersect the tubing at the desired angle. Next, the height of the cutting tool may be optionally adjusted to enable offset notching of the work piece by sliding the carriage assembly vertically along a length of the frame's side wall. The drive device is then activated and axial force applied thereto to bring the cutting tool in severing engagement with the work piece.

There has thus been outlined, rather broadly, the more important components and features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a tube notching apparatus capable of operable attachment to a powered rotational drive device such as a drill and further capable of performing straight, angled and offset notching.

It is another primary object of the subject invention to provide a tube notching apparatus designed to notch straight tubing of a wide variety of diameters.

Another object of the subject invention is to provide a tube notching apparatus capable of notching tubes which are either circular or square in cross section.

Still another object of the subject invention is to provide a tube notching apparatus designed to secure and maintain the work object in a substantially horizontal position regardless of the angle of notch being created thereby enabling the device to be located closer to surrounding walls if desired or necessary and reducing the overall work space required to perform notching tasks.

Yet another object of the subject invention is to provide a tube notching apparatus designed such that all major components are in close proximity to one another and constructed in such manner as to eliminate unwanted movement during operation thereby assuring proper alignment of cutting means and work object.

It is also an object of the subject invention to provide a tube notching apparatus that is comprised of relatively few components to facilitate easy assembly and use as well as reduce the chances of mechanical failure.

Another object of the subject invention is to provide a rotary tube notching apparatus which is relatively simple in design and therefore capable of rapid construction at relatively low costs.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front perspective view of the subject adjustable rotary tube notching apparatus having a cutting tool operatively mounted to the shaft assembly;

FIG. 2 is an exploded view of the rotary tube notching apparatus of FIG. 1;

FIG. 3 is an illustration of the subject invention adjusted to perform a straight cut on a mounted tube;

FIG. 4 is an illustration of the subject invention adjusted to perform an angled cut on a mounted tube; and

FIG. 5 is an illustration of the subject invention adjusted to perform an offset cut on a mounted tube.

### DETAILED DESCRIPTION OF THE PREFERRED EMBODIMENT

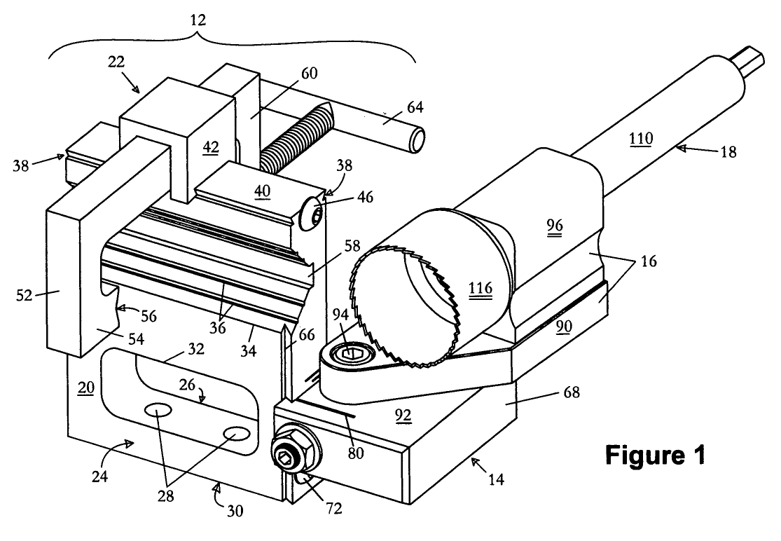

Reference is now made to FIG. 1 in which there is illustrated a front perspective view of the subject rotary tube notching apparatus (hereinafter sometimes also referred to as simply “notching apparatus” or “tube notcher”), designated generally by reference numeral 10. In its broadest sense, the subject invention is a rotary tube notching apparatus capable of operable attachment to a powered rotational drive device such as a drill, and is comprised of four primary components, namely a surface mountable tube support assembly 12; a height adjustable carriage assembly 14 slidably mounted to tube support assembly 12, a turret assembly 16 rotatably mounted to carriage assembly 14, and a shaft assembly 18 rotatably mounted within turret assembly 16. Each of these components is more fully described below, followed by a description of the functionality of the apparatus as a whole.

Tube support assembly 12 is comprised of a vertical frame 20, and tube retention means 22. Vertical frame 20 is preferably but not essentially substantially rectangular in shape and includes front side 24 (also referred to herein as “tube receiving side 24”) and rear side 26 (also referred to herein as “non-tube receiving side 26”). Vertical frame 20 further includes mounting means which in the embodiment illustrated is comprised of a pair of suitably sized bolt apertures 28 each situated between the bottom 30 of frame 20 and the interior of cutout 32 located in the lower portion of the frame. As may be appreciated, notching apparatus 10 may be bolted to a work surface using a pair of conventional bolts inserted through the work surface and through bolt apertures 28, preferably with the bolt heads installed head down so that the nuts will be visible in cutout 32 for tightening. Alternative methods of mounting notching apparatus 10 include: 1) c-clamping the frame 20 to the work surface utilizing cutout 32, 2) inserting the lower portion of frame 20 into a vice, or 3) mounting the apparatus directly to a work piece using tube support assembly 12 as further described herein whenever the work piece is already installed in an existing structure.

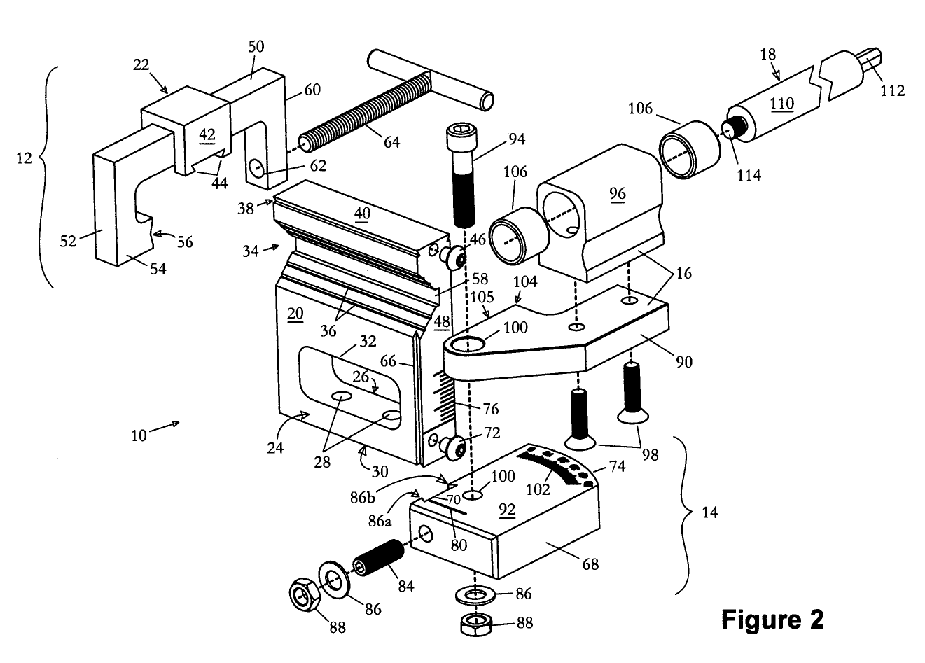

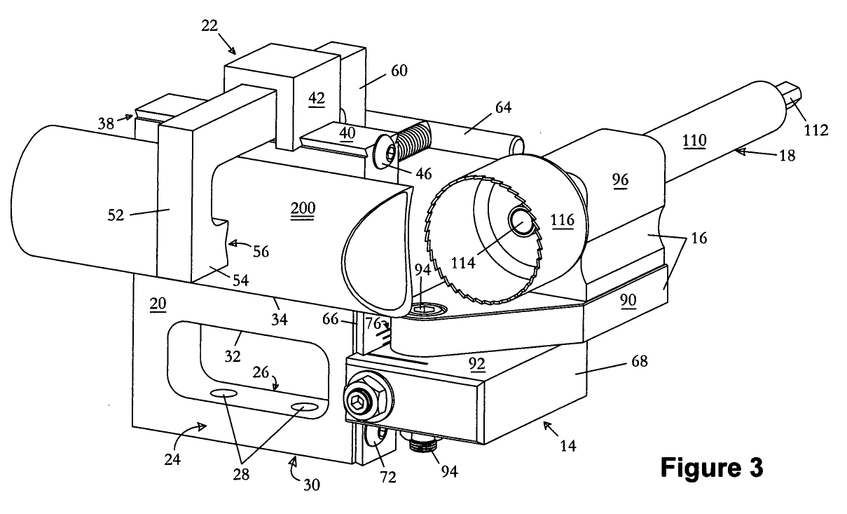

Reference now being made to FIG. 2, the subject apparatus is shown in exploded view to better illustrate the relationships between component parts. The top portion of frame 20 includes a tube receiver 34 comprised of a horizontally disposed recess and is preferably but not essentially V-shaped in cross section. The surface of tube receiver 34 is preferably scored, cast, machined or otherwise equipped with a plurality of longitudinal grooves 36 which are intended to reduce slippage of the work piece 200 when mounted therein (see FIGS. 3-5). A pair of horizontal rails 38 is recessed transversely across front side 24 and rear side 26 of frame 20 proximate its top 40 and are shaped to slidably receive therein tube support assembly 12. More specifically, a tube clamp slide 42 of tube support assembly 12 includes a pair of opposing teeth 44 adapted for slidable engagement with rails 38. A first stop bolt 46 threadedly received within the side 48 of frame 20 prevents tube clamp slide 42 from becoming disengaged with rails 38 at the same end. Tube retention means 12 further includes a substantially c-shaped tube clamp 50 slidably received within tube clamp slide 42 to permit movement perpendicular to front side 24 of frame 20. A first end 52 of tube clamp 50 includes angled foot member 54 having a transverse recess 56 in parallel and opposing relationship to the center groove 58 of tube receiver 34. A second end 60 of tube clamp 50 includes threaded handle aperture 64 adapted to receive reciprocally threaded t-handle 64. As best observed upon reference to FIGS. 3-5, angled foot member 54 is caused to be urged against the outer surface of a hollowed work piece 200 (“tube”) as t-handle 64 is tightened against the rear side 26 of frame 20 causing the work piece to become frictionally engaged within tube receiver 34. As may be appreciated, the right-angled shapes of both tube receiver 34 and opposing recess 56 of angled foot member 54 are ideal for engaging square tubing as well as round. Alternatively, tube retention means 22 may be comprised of any other suitable clamping device such as a C-clamp for instance.

Frame 20 further includes a pair of recessed vertical rails 66 adjacent side 48 of frame 20. Vertical rails 66 extend from the bottom 30 of frame 20 to the bottom edge of tube receiver 34, and are thus situate in the lower portion of frame 20 generally. Vertical rails 66 are shaped to slidably receive therein carriage assembly 14. More specifically, carriage assembly 14 includes a horizontal turret mounting platform 68 adapted with toothed recess 70 for slidable engagement with rails 66. A second stop bolt 72 threadedly received within the bottom of side 48 of frame 20 prevents turret mounting platform 68 from becoming disengaged from vertical rails 66 at the same end. Stop Bolt 72 further functions to allow carriage assembly 14 to be quickly and easily returned to the zero position after an offset notching operation described infra.

Turret mounting platform 68 is substantially rectangular in shape with the exception of its arced end 74. When mounted, turret mounting platform 68 occupies a plane perpendicular to that of frame 20 and extends in large part beyond the rear side 26. As should readily be appreciated, turret mounting platform 68 is height adjustable along the lower portion of frame 20 generally, and the lower portion of side 48 in particular which includes a scale 76 for accurate positioning. Turret mounting platform 68 is adapted with platform locking means for fixing the platform at a desired height relative to frame 20. In one embodiment, platform locking means is created by imparting a thin channel 80 through toothed recess 70 thereby forming two opposing teeth 82a,b which may be biased together, closing channel 80, using a set screw 84, machine bushing 86 and jam nut 88 in a manner well known to those skilled in the art.

With continued reference to FIG. 2, turret assembly 16 is comprised of swivel plate 90 pivotally mounted over top surface 92 of turret mounting platform 68 using recessed and partially threaded pivot bolt 94, and bearing block 96 fixedly mounted atop swivel plate 90 using two recessed flat head bolts 98. As may be observed, both turret mounting platform 68 and swivel plate 90 include pivot bolt holes 100 which are concentrically aligned to receive pivot bolt 94 there through. Turret mounting platform 68 includes a curved angle scale 102 about its arced end for measuring the degree of rotation of swivel plate 90 about its axis of rotation. An elbow 104 of overlying swivel plate 90 serves as the pointer. Note that when edge 105 of swivel plate 90 is abutted against the surface of adjacent side wall 48 of frame 20, elbow 104 will ‘point to’ zero degrees on angle scale 102. Pivot bolt 94 may be selectively loosened and tightened to permit movement of turret assembly 16 about its axis of rotation or to lock it into a desired notching angle relative to the longitudinal axis of work piece 200, respectively.

Bearing block 96 houses a pair of needle bearings 106 (preferably but not essentially 1″ inner diameter double-sealed) within its horizontal shaft aperture 108. Shaft 110 is slidably and rotatably mounted horizontally through bearing block 96 generally and needle bearings 106 specifically. The distal end 112 of shaft 110 (relative to frame 20) is adapted for operative engagement with a powered rotational drive device, preferably a ½″ drill and has been milled on three sides to prevent the chuck from slipping and therefore works well with a keyless chuck. The opposite or proximal end 114 of shaft 110 is threaded for operative engagement with cutting tool 116, namely a bimetallic hole saw (FIGS. 3-5). Note that the axis of rotation of shaft 110 will lie on the same plane as the longitudinal axis of tube receiver 34 when turret mounting platform 68 is ‘zeroed out’ on scale 76 (i.e., when lowered to lie against second bolt stop 72). Thusly positioned, straight or angled cuts may be performed on a work piece 100 mounted in tube receiver 34 while assuring that the axis of rotation of cutting tool 116 intersects the longitudinal axis of the work piece regardless of the selected angle of penetration. Offset cuts (i.e., when the saw's axis of rotation does not intersect with the longitudinal axis of the work piece) may be performed by adjusting carriage assembly 14 upward to the desired height, thereby elevating cutting tool 116 as well. It is worth noting at this point that where the tube to which the notched tube is to be joined is of substantially the same diameter as the notched tube, cutting tool 116 should be of substantially the same diameter of the tube being notched. However, when the diameter of the tube to which the notched tube is to be joined is of larger diameter than the notched tube, the cutting tool 116 must be of similarly larger diameter to assure proper mating conformation.

### Methods of Use

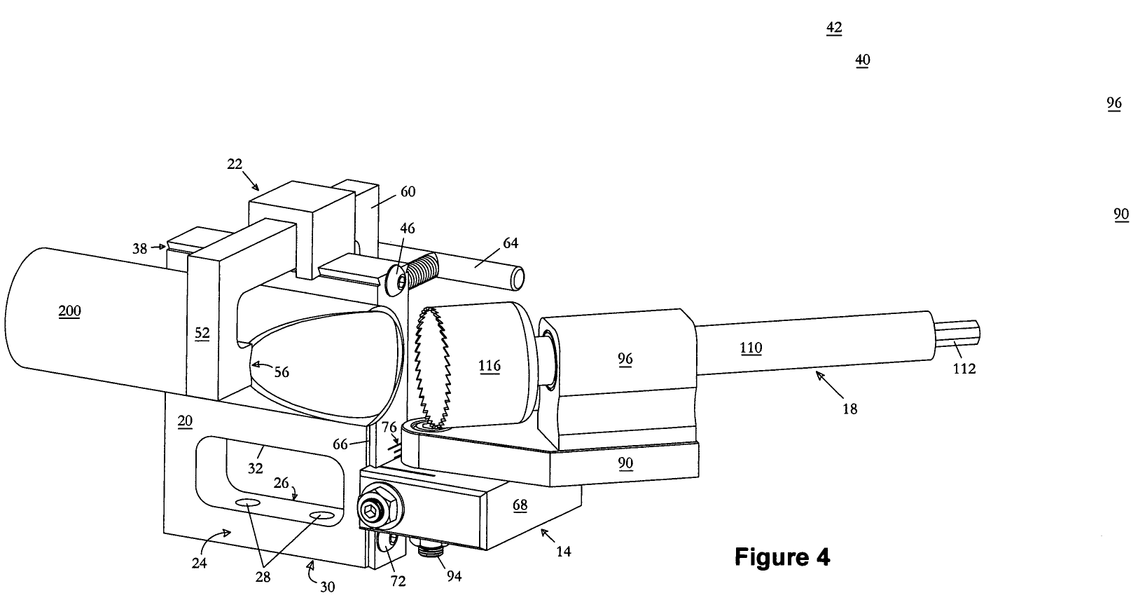

In practice, cutting member 116 and a hand drill (not shown) are operatively mounted to opposite ends of shaft 110 in the conventional manner. Referring to FIGS. 3 and 4 methods of performing straight and angled cuts, respectively, may now be described. First, a length of straight tubing 200 is secured to the subject notching apparatus 10 by tightening t-handle 64 until angled foot member 54 of tube clamp 50 engages the surface of the work piece and forces it against tube retainer 34 of tube support assembly 12. It is preferred to position tube retention means 22 as close as possible to cutting tool 116. Thereafter, carriage assembly 14 will be rotated about pivot bolt 94 until the axis of rotation of the cutting tool is aligned to intersect the tubing at the desired angle as may be observed on angle scale 102. The drive device is then activated and axial force applied thereto to bring cutting tool 110 in severing engagement with the work piece in a manner well known to those skilled in the art.

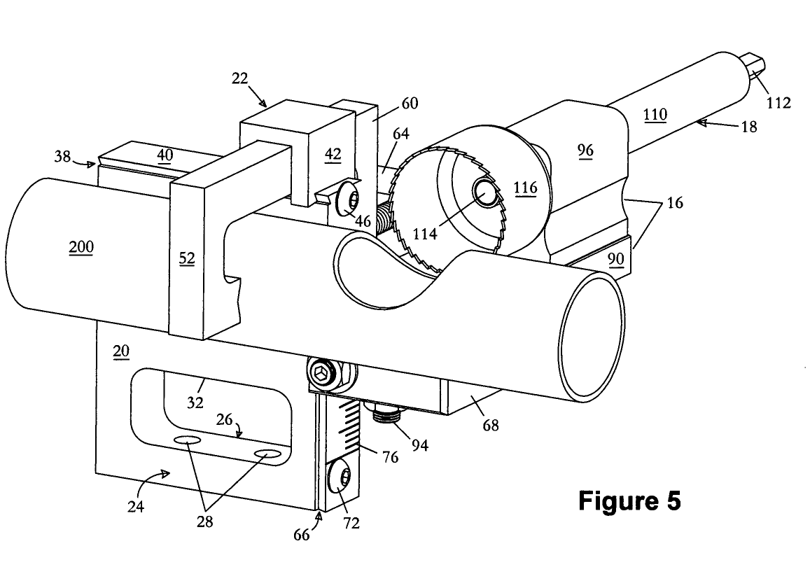

For offset notching (illustrated in FIG. 5) the same procedure as described immediately above is followed, however, the height of cutting member 116 will be adjusted until the desired offset relative to the work piece is achieved as may be measured on scale 76.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A rotary tube notching apparatus capable of operable attachment to a powered rotational drive device such as a drill, the apparatus comprising:
a. a tube support assembly for receiving a length of straight tubing;
b. a height adjustable carriage assembly slidably mounted to said tube support assembly;
c. a turret assembly rotatably mounted to said carriage assembly; and
d. a shaft rotatably mounted within said turret assembly for operable engagement with a cutting tool and a powered rotational drive device at opposite ends.

2. The rotary tube notching apparatus of claim 1, wherein said tube support assembly is comprised of a vertical frame member having a tube receiver.

3. The rotary tube notching apparatus of claim 2, wherein said tube receiver is recessed.

4. The rotary tube notching apparatus of claim 3, wherein said tube receiver is v-shaped.

5. The rotary tube notching apparatus of claim 1, wherein said height adjustable carriage assembly is comprised of a horizontal turret mounting platform in slidable engagement with said tube support assembly.

6. The rotary tube notching apparatus of claim 5, wherein said turret assembly is comprised of a swivel plate in pivotal engagement with said turret mounting platform, and a bearing block fixedly mounted to said swivel plate; said swivel plate having said shaft rotatably mounted therein along a horizontal axis.

7. The rotary tube notching apparatus of claim 1, wherein said turret assembly is mounted above said carriage assembly.

8. The rotary tube notching apparatus of claim 2, wherein said carriage assembly is perpendicular to said frame.
